(19) United States
(12) Patent Application Publication
(10) Pub. No.: US 2026/0272750 A1
(43) Pub. Date: Sep. 17, 2026

(54) POWER, DATA AND MEDICAL GAS CEILING OUTLET MODULE

(71) Applicant: Flexible OR Solutions LLC, Dripping Springs, TX (US)

(72) Inventor: Scott Hodsden, Dripping Springs, TX (US)

(21) Appl. No.: 19/441,021

(22) Filed: Jan. 6, 2026

Related U.S. Application Data
(60) Provisional application No. 63/771,880, filed on Mar. 14, 2025.

(51) Int. Cl. A61G 12/00

(52) U.S. Cl. CPC A61G 12/004

(57) ABSTRACT

A ceiling outlet module having a frame assembly with a rigid outer edge sized for placement within a ceiling grid assembly and a plurality of flexible interchangeable data ports, medical gas connector port, and electrical power port, each having a respective medical gas connector, data line connector and electrical power port connector, for connection of data line passing through a track assembly above the ceiling grid assembly to operating room equipment.

### PRIORITY

The present invention claims priority to U.S. 63/771,880 filed Mar. 14, 2025, the entirety of which is hereby incorporated by reference.

### TECHNICAL FIELD

This disclosure relates to a clinical environment accessory and specifically to a ceiling outlet module for providing room-side power, data and medical gas outlets for users of a clinical environment.

Traditionally, when a hospital or outpatient surgical facility wishes to improve, relocate or add surgical room equipment that is ceiling mounted or interfaced with equipment located in the interstitials space of the operating room, the operating room must be closed for extended periods of time while the new equipment is placed or the improvement is executed.

A universal, flexible operating room ceiling system solution installed during operating room facility construction is described in U.S. Pat. No. 11,408,170 issued to Applicant. The operating room ceiling system so described does not interfere with or prohibit utilization of the operating room and at the same time can accommodate virtually any surgical equipment configuration, future changes to the type and location of the surgical equipment, as well as building infrastructure requirements.

### SUMMARY

Components of an operating room including structural components, medical gas lines, electrical and data lines and heating, ventilation and cooling equipment are moveable in operating rooms in which a universal operating room ceiling system is installed. Future positioning, repositioning and placement of operating room equipment and associated medical gas lines and power requirements is made possible by such a universal ceiling system. A track assembly is positioned on a pre-fabricated grid directly above the ceiling in the interstitial space. A ceiling assembly includes air diffusers and lighting fixtures. The track assembly is configured to provide access to facilitate routing of cables, medical gas lines, and electrical conduit for electrical power. Installation of a ceiling outlet module of the present invention provides compact, robust and flexible room-side access to power, data, and medical gas lines as required by operating room arranged within the operating room and subsequent repositioning of such equipment.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 depicts side view of a track and heating, cooling and ventilation equipment supported by a grid of red-iron frame and modular steel rails according to an embodiment;

FIG. 2 depicts a perspective view of a ceiling outlet module according to an embodiment;

FIG. 3 depicts a side view of a ceiling outlet module installed in ceiling assembly 618 according to an embodiment.

### DETAILED DESCRIPTION

In the following detailed description of exemplary embodiments of the invention, specific exemplary embodiments in which the invention may be practiced are described in sufficient detail to enable those skilled in the art to practice the invention, and it is to be understood that other embodiments may be utilized and that architectural, mechanical, electrical and other changes may be made without departing from the spirit or scope of the present invention. The following detailed description is, therefore, not to be taken in a limiting sense, and the scope of the present invention is defined only by the appended claims and their equivalents.

A rectangular track assembly, or raceway, made of a variety of materials including plastic and sheet metal is positioned above the ceiling vertically between ceiling level air diffusers and light fixtures and HVAC duct work. The track assembly is a rectangular or tubular trough that houses medical gases needed in the operating room as well as electrical and data lines. The track assembly is often comprised of various sections in one embodiment, including at least one removable or closeable access panels on the bottom of the track that is substantially parallel to the ceiling below. Some track assembly designs include openings at various intervals allowing access to medical gas lines and electrical and data lines contained therein. Components enter a desired area in the track assembly and are then distributed to where ceiling mounted equipment is to be located. In one or more embodiments, the ceiling mounted equipment is mechanically coupled to a structural support by an intermediate structure that receives a portion of the track assembly and includes an equipment mounting plate. The track assembly allows medical gas lines, electrical cables, and communication cables to be readily rerouted if the ceiling mounted equipment is moved or upgraded or additional ceiling mounted equipment is added.

With the track assembly and complete structural support positioned above the ceiling, equipment can be placed anywhere in the area within the ceiling system frame and grid. If new equipment is required to be installed, the location of the new equipment is not limited by the placement of the old equipment and can be located anywhere within the frame and grid. The footprint of the track assembly and structural support covers the operating area within the operating room, which is typically the center of the room, and can extend outward from the room's center. The lighting installed in the universal frame and grid provides ample lighting of the patient area, access to ceiling mounted equipment, and one or more light fixtures can be readily removed to provide access to the track assembly. In addition, the air diffuser provides a clean patient area.

Optionally, the ceiling assembly can include air diffusers used to circulate clean air over an operating table. For example, the air diffuser assembly can include a plurality of high-efficiency particle absorption (HEPA) filtered air vents or non-HEPA filtered air vents.

A support structure integrated above the ceiling is configured to support the operating room ceiling system and ceiling mounted surgical equipment (anesthesia booms, surgical lights, etc.) via modular steel rails, such as Hilti brand rails. In various embodiments, surgical equipment may be positioned anywhere within the ceiling frame and grid system. According to various aspects of the present disclosure, additional surgical equipment can be added with little to no structural support cost by simply making medical gas lines and electrical and data cabling available through the track assembly and structurally attaching the added equipment to the modular steel rails. The presently described ceiling system can be readily re-configured as needed. For example, removable bottom panels of the track assembly can be relocated to another location on the track assembly (or replaced with new panels) when various equipment requires relocation.

In various embodiments, communication cables are pulled into the track assembly and routed to specific equipment. In one or more embodiments, medical gas is hard piped to a top wall of the track assembly and a hose inside the track assembly is employed to deliver the gas to a desired location. Similarly, power is provided inside the track assembly and conduit (rigid or flexible) and junction-boxes can be employed to distribute power throughout the track assembly.

The track assembly can be used to distribute medical gas lines, power cables, and/or communication cables to various ceiling mounted surgical equipment, as well as any other devices that are incorporated into the track assembly. In one or more embodiments, the track assembly includes several sheet metal or plastic track boxes

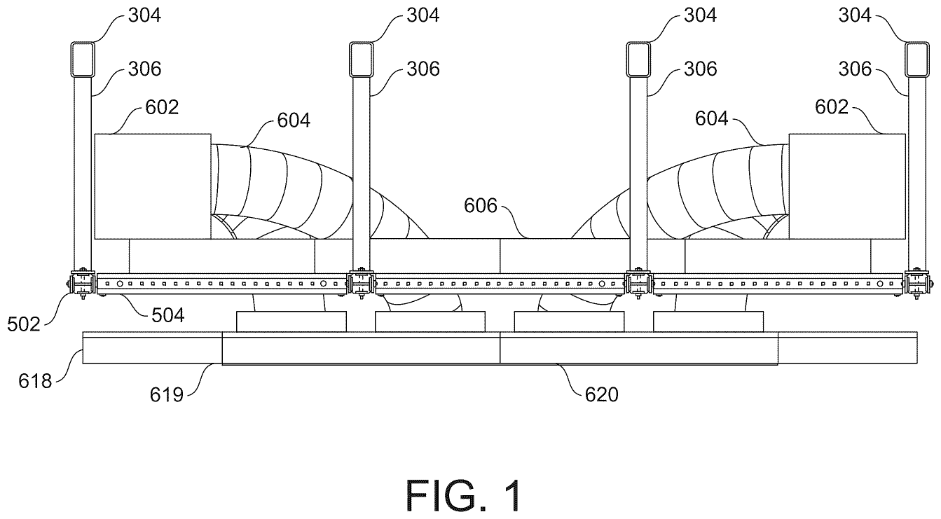

FIG. 1 provides a side view of a universal operating room ceiling system in which an embodiment of the presently described ceiling outlet module is installed. FIG. 1 provides a side view of a partially assembled operating room ceiling system according. As shown in FIG. 1, the red iron frame and grid arrangement comprising the modular steel rails 502 connected to red iron frame vertical legs 306 serves as the support structure for medical equipment, HVAC duct work, diffusers and a track assembly for housing medical gas lines and electrical and data lines and provides structural support for medical equipment. Track assembly 606 is arranged directly above modular steel rails 502 that are placed as a grid. Track assembly 606 can be rectangular and tubular in shape and provided in sections for ease of installation and assembly. In some systems, track assembly 606 is arranged as a rectangle extending close to the perimeter of the grid formed by modular steel rails 502.

Also shown in FIG. 1 are HVAC trunk lines 602 installed above track assembly 606. Trunk lines 602 includes multiple ports to which HVAC ducts 604 are connected in order to provide adequate air circulation to the operating room. A lower end of each HVAC duct 604 is connected to ceiling assembly 618 having at least one diffuser 620 through which recirculated and filtered air is returned to the operating room. Ceiling assembly 618 and diffuser 620 in one embodiment is flush with the interior ceiling of the operating room. Ducts 604 as will be discussed reside within the interior of the rectangle formed by track assembly 606 in order to avoid interference with operating room equipment connection to medical gas lines and electrical and data cables both during new construction and later repositioning or adding or removal of equipment. That is, the duct ports preinstalled in trunk line 602 face the interior of the grid formed by the modular steel rails 502. The corresponding HVAC ducts 604 will connect to air diffusers located within the perimeter of track assembly 606.

In one embodiment, track assembly 606 supports attachment of medical columns or booms through which hoses carrying medical gas, as well as electrical cables, data cables, etc. In at least one embodiment, ceiling assembly is the lowest layer of the universal ceiling system and serves as the interior ceiling of the operating room or clinical space. Ceiling assembly 618 includes one or more diffusers 620 that can be HEPA diffusers. Ceiling assembly 618 in one embodiment can also include light assembly 619. Track assembly 606 is positioned directly above the grid formed by modular steel rails 502 and 504. Above and to the outside of track assembly 606 are HVAC trunk lines 602. Below track assembly 606 is ceiling assembly 618. Ceiling assembly 618 in one embodiment comprises a number of separate panels of typical dimensions for commercial ceiling tiles. Some of these separate panels can be diffuser panels 620 and lighting panels 619. Optionally, lighting panels 619 can include a plurality of troffers, including, LED, fluorescent, or incandescent troffers.

In connection with ceiling systems such as the one described above, repositioning of operating room equipment is contemplated and made available through the flexibility offered by the track assembly. The ability to run data, electrical and medical gas lines throughout the track assembly, and access panels provided in the track assembly permit easy repositioning of equipment without construction process interruptions. The ceiling system described above is an exemplary embodiment of a ceiling configuration in a surgical, outpatient or other medical setting, but is by no means limiting. The presently described ceiling outlet module accommodates structures having various configurations.

The presently described ceiling outlet module in one embodiment works in conjunction with the track assembly's or raceway's provisioning of medical gas, data and electrical lines to provide room-side power, data and medical gas outlets throughout the operating room space. Use of the presently described ceiling outlet module operates with in the same manner in connection with other ceiling systems. In one embodiment, the presently described ceiling outlet module is of a size that permits it to occupy ceiling spaces in conjunction with ceiling diffusers and light assemblies. The ceiling outlet module of the present invention in one embodiment in a retrofit context replaces one or more diffusers or light assemblies providing direct access to data, power and medical gas for the operating room users and equipment below. In other embodiments, at initial installation of the ceiling system, one or more ceiling outlet modules are installed in the first on the same plane as light assemblies and diffusers in ceiling assembly 618. Under either scenario, one or more ceiling outlet modules provide compact, robust and flexible room-side power, data and medical gas access.

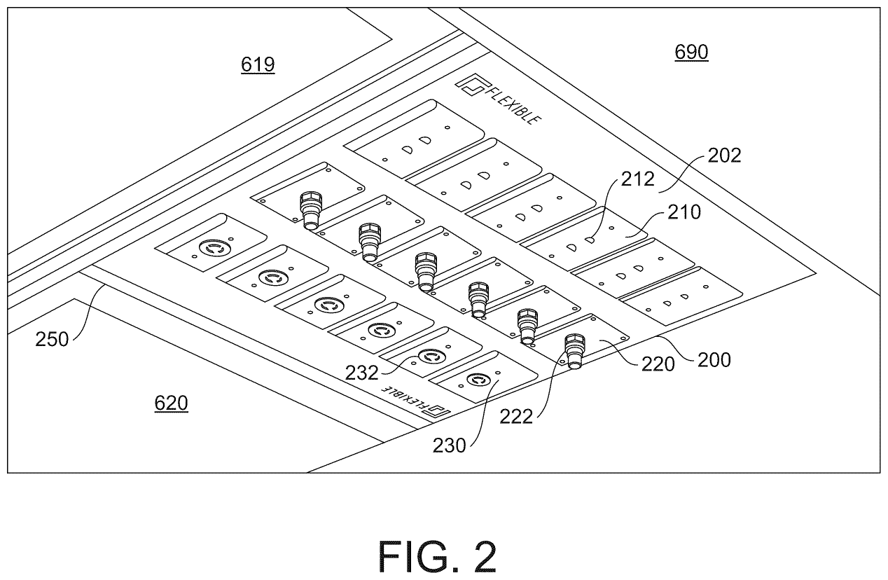

FIG. 2 depicts a perspective view of a ceiling outlet module according to an embodiment for placement of the presently described ceiling outlet module within an operating room ceiling assembly such as ceiling assembly 608 of FIG. 1. Note, however, that the operating room universal ceiling system and ceiling assembly 608 described is only one example of the environment in which the presently described ceiling outlet module is installed. Installation of the ceiling outlet module described herein is appropriate in any clinical setting in which room-side power, data and medical gas access is necessary. In FIG. 2, ceiling outlet module 200 includes a frame 202 that forms a rigid outer edge of module 200 that is sized for placement within a ceiling grid assembly 250 for receipt and securing of light fixtures, diffusers and the like.

As shown in FIG. 2, in an embodiment ceiling outlet module 200 includes eighteen flexible connection ports that are interchangeable. In the embodiment shown, there are six each of data ports 210, medical gas connector ports 220 and electrical power ports 230. Each data port 210 includes data line outlets 212. Each medical gas connector port 220 includes a medical gas connector 222. Each electric power port 230 includes electrical outlet 232. In one embodiment, ports 210, 220 and 230 have the same outer dimensions and are interchangeable. That is, rather than six of each type of port as shown, the ports are moveable and interchangeable. The user can select to install all or none of one type of port within the module. Further, in the embodiment shown, ceiling outlet module 200 accommodates eighteen modules but a larger frame 202 accommodates more than eighteen ports and a smaller frame 202 accommodates fewer than eighteen ports. In addition, “blank” or ports can be inserted to replace one or more ports, resulting in an “empty” port in which none of power, data or medical gas is provided. Ceiling outlet module is customizable in this respect to provide the needed room-side assets.

Continuing with FIG. 2, data line outlet 212 as shown in one embodiment is an RJ11 or RJ45 data port. In other embodiments, various types of data line outlets are accommodated, such as for USB A, USB C, HDMI, VGA, coaxial or other known lines and corresponding ports required for a particular setting. Medical gas connector ports 220 include medical gas connectors 222 of the type and size as is customary to provide medical gas through a tube to a desired device in the operating room at a desired location. Once such medical gas port or outlet is a diameter-index safety system outlet (DISS). In one embodiment, medical gas connector 222 is configured to receive and secure a “pull and release” hose end for connection of a medical gas source. Other medical gas connectors may be substituted to accommodate hose ends of different types. Electrical power port 230 includes electrical outlet 232. In an embodiment as shown, electrical outlet 232 is of the twist-lock variety to prevent accidental removal, which is typical to accommodate the electrical plug of various operating room equipment. Other types of outlets are suitable, however, to provide various voltages as suitable for the various equipment. Overall, the examples of power, data and medical gas lines and outlets described herein are not limiting. The presently described ceiling outlet module accommodates other types of lines and corresponding outlets or ports as required by the particular setting.

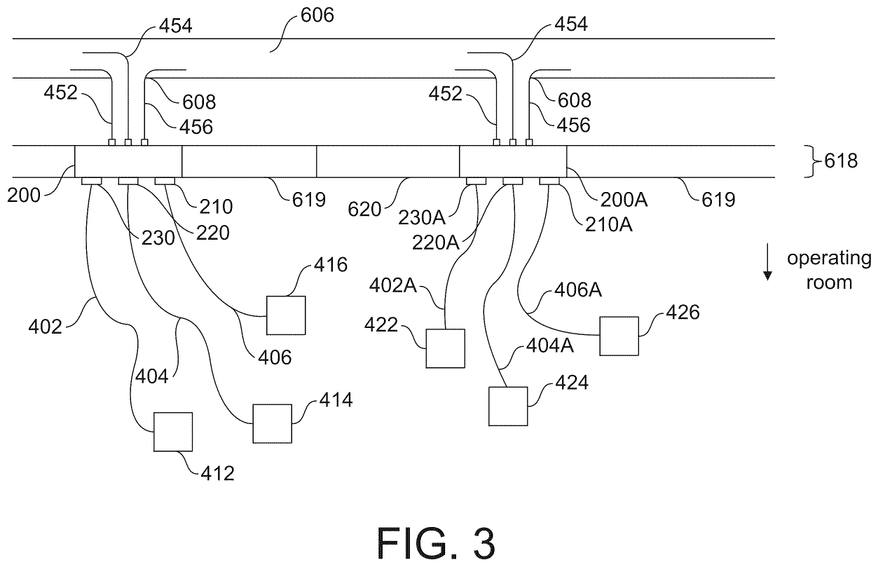

FIG. 3 depicts a side view of a ceiling outlet module installed in ceiling assembly 618 according to an embodiment. In FIG. 3, a pair of ceiling outlet modules 200 and 200A are installed in ceiling assembly 618. In this configuration, the ports described above of ceiling outlet module 200 are in the operating room space and accessible for connection to medical and other equipment in the room. Ceiling assembly 618 as shown includes lighting assemblies 619 and a diffuser 620 with ceiling outlet modules 200 and 200A installed in the ceiling grid alongside. Any number of ceiling outlet modules, lighting assemblies and diffusers may be disposed within an area of ceiling assembly 618 and the arrangement shown is but one of many possible arrangements.

Above ceiling assembly 618 resides track assembly or raceway 606. Other components located above ceiling assembly 618 are not shown for the sake of ease of illustration, but it is noted that other components reside typically above ceiling assembly 618. Within track assembly 606 are electrical power supply line 452, medical gas supply line 454 and data line 456. As shown, each of the two ceiling outlet modules are connected to one of each of these lines at a connection port on the back of ceiling outlet module. Track assembly access doors 608 allow access to lines 452, 454 and 456 running within track assembly 606 for external connection to ceiling outlet module 200 and 200A as shown.

Operating room devices 412, 414, and 416 and ceiling outlet module 200 are connected by room-side electrical line 402, room-side medical gas line 404 and room-side data line 406, respectively. Room-side electrical line 402 is connected to ceiling outlet module 200 via electrical power port 230. Room-side medical gas line 404 is connected to ceiling outlet module 200 via medical gas connector port 220. Room-side data line 406 is connected to ceiling outlet module 200 via data port 210. Similarly, operating room devices 422, 424 and 426 and ceiling outlet module 200A are connected by room-side electrical line 402A, room-side medical gas line 404A and room-side data line 406A, respectively. Room-side electrical line 402A is connected to ceiling outlet module 200A via electrical power port 230A. Room-side medical gas line 404A is connected to ceiling outlet module 200 via medical gas connector ports 220A. Room-side data line 406A is connected to ceiling outlet module 200 via data port 210A. As shown, ceiling outlet modules 200 and 200A provide a flexible, convenient and effective means for accessing and providing necessary power, data, and medical gas to various equipment in the operating room space when source lines reside in an above the ceiling track assembly or raceway.

Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included within the scope of the present invention. Any benefits, advantages, or solution to problems that are described herein with regard to specific embodiments are not intended to be construed as a critical, required, or essential feature or element of any or all the claims.

### ADDITIONAL DISCLOSURE

The following clauses are offered as further description of the disclosed invention.

Clause 1. A ceiling outlet module, comprising:
a frame assembly having a rigid outer edge sized for placement within a ceiling grid assembly; for receipt and securing of a light fixture and a diffuser;
a plurality of flexible interchangeable connection ports; comprising:
   at least one data port, each having a data line outlet;
   at least one medical gas connector port, each having a medical gas connector; and
   at least one electrical power port, each having an electrical outlet;
   wherein each data port, medical gas connector port and electrical power port have the same outer dimensions,
   wherein each data port, medical gas connector port and electrical power port are disposed on a room-interior side of the ceiling outlet module,
   wherein each data port, medical gas connector port and electrical power port has a corresponding data input, medical gas input and electrical power input on an above-the-ceiling side of the ceiling outlet module.

Clause 2. The ceiling outlet module of any preceding or proceeding claim, wherein the data input, medical gas input and electrical power input is connectable to a respective data line, medical gas supply line and electrical power supply line.

Clause 3. The ceiling outlet module of any preceding or proceeding claim, wherein the at least one data port is connectable to a room-side data line.

Clause 4. The ceiling outlet module of any preceding or proceeding claim, wherein the at least one electrical power port is connectable to a room-side electrical line.

Clause 5. The ceiling outlet module of any preceding or proceeding claim, wherein the at least one medical gas connector port is connectable to a room-side medical gas line.

Clause 6. The ceiling outlet module of any preceding or proceeding claim, wherein an operating room medical equipment is connectable to the room-side medical gas line, the room-side data line and the electrical line.

Clause 7. The ceiling outlet module of any preceding or proceeding claim, wherein an above-the-ceiling medical gas line is connectable to the medical gas input.

Clause 8. The ceiling outlet module of any preceding or proceeding claim, wherein an above the ceiling data line is connectable to the data input.

Clause 9. The ceiling outlet module of any preceding or proceeding claim, wherein an above the ceiling electrical power line is connectable to the electrical input.

Clause 10. The ceiling outlet module of any preceding claim, wherein the above the ceiling medical gas line, the above the ceiling data line and the above the ceiling electrical power line are disposed within a track assembly disposed above the ceiling grid assembly.

Clause 11. An operating room equipment system, comprising:
a ceiling outlet module, comprising:
   a frame assembly having a rigid outer edge sized for placement within a ceiling grid assembly; for receipt and securing of a light fixture and a diffuser;
   a plurality of flexible interchangeable connection ports; comprising:
   at least one data port, each having a data line outlet;
   at least one medical gas connector port, each having a medical gas connector; and
   at least one electrical power port, each having an electrical outlet;
wherein each data port, medical gas connector port and electrical power port have the same outer dimensions,
wherein each data port, medical gas connector port and electrical power port are disposed on a room-interior side of the ceiling outlet module,
wherein each data port, medical gas connector port and electrical power port has a corresponding data input, medical gas input and electrical power input on an above-the-ceiling side of the ceiling outlet module.

Clause 12. The operating room equipment system of any preceding or proceeding claim, further comprising a data line, medical gas supply line and electrical power supply line connectable to the respective the data input, medical gas input and electrical power input.

Clause 13. The operating room equipment system of any preceding or proceeding claim, further comprising a room-side data line connectable to the at least one data port.

Clause 14. The operating room equipment system of any preceding or proceeding claim, further comprising a room-side electrical line connectable to the at least one electrical power port.

Clause 15. The operating room equipment system of any preceding or proceeding claim, further comprising a room-side medical gas line connectable to the at least one medical gas connector port.

Clause 16. The operating room equipment system of any preceding or proceeding claim, further comprising operating room medical equipment connectable to the room-side medical gas line, the room-side data line and the electrical line.

Clause 17. The operating room equipment system of any preceding or proceeding claim, further comprising an above-the-ceiling medical gas line connectable to the medical gas input.

Clause 18. The operating room equipment system of any preceding or proceeding claim, further comprising an above-the-ceiling data line connectable to the data input.

Clause 19. The operating room equipment system of any preceding or proceeding claim, further comprising an above the ceiling electrical power line connectable to the electrical input.

Clause 20. The operating room equipment system of any preceding claim, further comprising a track assembly disposed above the ceiling grid assembly and containing the above the ceiling medical gas line, the above the ceiling data line and the above the ceiling electrical power line.

What is claimed is:

1. A ceiling outlet module, comprising:
a frame assembly having a rigid outer edge sized for placement within a ceiling grid assembly;
for receipt and securing of a light fixture and a diffuser;
a plurality of flexible interchangeable connection ports; comprising:
at least one data port, each having a data line outlet;
at least one medical gas connector port, each having a medical gas connector; and
at least one electrical power port, each having an electrical outlet;
wherein each data port, medical gas connector port and electrical power port have the same outer dimensions,
wherein each data port, medical gas connector port and electrical power port are disposed on a room-interior side of the ceiling outlet module,
wherein each data port, medical gas connector port and electrical power port has a corresponding data input, medical gas input and electrical power input on an above-the-ceiling side of the ceiling outlet module.

2. The ceiling outlet module of claim 1, wherein the data input, medical gas input and electrical power input is connectable to a respective data line, medical gas supply line and electrical power supply line.

3. The ceiling outlet module of claim 1, wherein the at least one data port is connectable to a room-side data line.

4. The ceiling outlet module of claim 1, wherein the at least one electrical power port is connectable to a room-side electrical line.

5. The ceiling outlet module of claim 1, wherein the at least one medical gas connector port is connectable to a room-side medical gas line.

6. The ceiling outlet module of claim 5, wherein an operating room medical equipment is connectable to the room-side medical gas line, the room-side data line and the electrical line.

7. The ceiling outlet module of claim 1, wherein an above-the-ceiling medical gas line is connectable to the medical gas input.

8. The ceiling outlet module of claim 7, wherein an above the ceiling data line is connectable to the data input.

9. The ceiling outlet module of claim 8, wherein an above the ceiling electrical power line is connectable to the electrical input.

10. The ceiling outlet module of claim 9, wherein the above the ceiling medical gas line, the above the ceiling data line and the above the ceiling electrical power line are disposed within a track assembly disposed above the ceiling grid assembly.

11. An operating room equipment system, comprising:
a ceiling outlet module, comprising:
a frame assembly having a rigid outer edge sized for placement within a ceiling grid assembly; for receipt and securing of a light fixture and a diffuser;
a plurality of flexible interchangeable connection ports; comprising:
at least one data port, each having a data line outlet;
at least one medical gas connector port, each having a medical gas connector; and
at least one electrical power port, each having an electrical outlet;
wherein each data port, medical gas connector port and electrical power port have the same outer dimensions,
wherein each data port, medical gas connector port and electrical power port are disposed on a room-interior side of the ceiling outlet module,
wherein each data port, medical gas connector port and electrical power port has a corresponding data input, medical gas input and electrical power input on an above-the-ceiling side of the ceiling outlet module.

12. The operating room equipment system of claim 11, further comprising a data line, medical gas supply line and electrical power supply line connectable to the respective the data input, medical gas input and electrical power input.

13. The operating room equipment system of claim 12, further comprising a room-side data line connectable to the at least one data port.

14. The operating room equipment system of claim 13, further comprising a room-side electrical line connectable to the at least one electrical power port.

15. The operating room equipment system of claim 14, further comprising a room-side medical gas line connectable to the at least one medical gas connector port.

16. The operating room equipment system of claim 15, further comprising operating room medical equipment connectable to the room-side medical gas line, the room-side data line and the electrical line.

17. The operating room equipment system of claim 11, further comprising an above-the-ceiling medical gas line connectable to the medical gas input.

18. The operating room equipment system of claim 17, further comprising an above-the-ceiling data line connectable to the data input.

19. The operating room equipment system of claim 18, further comprising an above the ceiling electrical power line connectable to the electrical input.

20. The operating room equipment system of claim 19, further comprising a track assembly disposed above the ceiling grid assembly and containing the above the ceiling medical gas line, the above the ceiling data line and the above the ceiling electrical power line.
